(19) United States
(12) Patent Application Publication
(10) Pub. No.: US 2019/0077049 A1
(43) Pub. Date: Mar. 14, 2019

(54) POLISHING PAD MATERIAL PURIFICATION SYSTEM

(71) Applicant: NITTA HAAS INCORPORATED, Osaka (JP)

(72) Inventors: Katsumi KAWASE, Mie (JP); Yoshitane SHIGETA, Kyoto (JP); Masahito YAMAKOSHI, Mie (JP)

(21) Appl. No.: 15/742,976

(22) PCT Filed: Jul. 8, 2016
(86) PCT No.: PCT/JP2016/070295

§ 371 Date: Jan. 9, 2018

(30) Foreign Application Priority Data
Jul. 10, 2015 (JP) 2015-138946

(51) Int. Cl. B29B 13/10; B29B 13/02; B29B 7/10

(52) U.S. Cl. CPC B29B 13/10; B24D 18/009; B29B 7/10; B29B 13/022

(57) ABSTRACT

A polishing pad material purification system includes a melting device configured to melt a solid material put therein, and a homogenizer configured to homogenize the material melted in the melting device. The homogenizer is configured to have a processable amount of material to be homogenized larger than a processable amount of material to be melted by the melting device and configured to stir the material melted in the melting device so as to homogenize it.

### CROSS-REFERENCE TO RELATED APPLICATION

This application claims priority to Japanese Patent Application No. 2015-138946, the disclosure of which is incorporated herein by reference in its entirety.

### FIELD

The present invention relates to a polishing pad material purification system configured to purify a material for producing polishing pads.

### BACKGROUND

Conventionally, polishing pads are produced using a liquid material purified by melting a solid material (for example, see Patent Literature 1). Therefore, in order to produce polishing pads, a polishing pad material purification system (which will be hereinafter referred to as material purification system) configured to purify a liquid material from a solid material is used.

The material purification system, for example, includes an inlet into which the solid material is put, a melting unit configured to melt the solid material put into the inlet, and an outlet from which the material melted in the melting unit is discharged.

Therefore, in the material purification system, the material that is changed from solid state to liquid state by the melting unit is discharged from the outlet as a material for producing polishing pads.

Meanwhile, the properties such as the size and distribution of components of solid materials to be put into the inlet are different from each other, and therefore the molten state or mixed state of the material discharged from the outlet varies depending on each solid material put therein. Accordingly, when polishing pads are produced using a material purified by a conventional material purification system, the properties of the produced polishing pads may vary in some cases.

### CITATION LIST

### Patent Literature

Patent Literature 1: JP 2008-137355 A

### SUMMARY

### Technical Problem

In view of such circumstances, it is an object of the present invention to provide a polishing pad material purification system configured to purify a material so as to have high homogeneity.

### Solution to Problem

A polishing pad material purification system according to the present invention includes: a melting device configured to melt a solid material; and a homogenizer configured to homogenize the material melted in the melting device, wherein the homogenizer is configured to have a processable amount of material to be homogenized larger than a processable amount of material to be melted by the melting device and configured to stir the material melted in the melting device so as to homogenize it.

According to an embodiment, the polishing pad material purification system according to the present invention may be configured so that the melting device is configured to stir the melted material so as to homogenize it.

According to another embodiment, the polishing pad material purification system according to the present invention may be configured so that at least any one of the melting device and the homogenizer includes a circulation path through which the melted material is circulated to be stirred.

According to another embodiment, the polishing pad material purification system according to the present invention may be configured so that at least any one of the melting device and the homogenizer includes a filtration device configured to filter the melted material.

According to still another embodiment, the polishing pad material purification system according to the present invention may be configured so that the melting device includes a supply pipe fluidically connected to the homogenizer.

### BRIEF DESCRIPTION OF DRAWINGS

FIG. 1 is a schematic view of a polishing pad material purification system according to an embodiment of the present invention.

FIG. 2 is an explanatory diagram of the polishing pad material purification system according to the embodiment, in which a material put into a melting device is melted.

FIG. 3 is an explanatory diagram of the polishing pad material purification system according to the embodiment, in which the material melted in the melting device is homogenized by a homogenizer.

FIG. 4 is an explanatory diagram of the polishing pad material purification system according to the embodiment, in which a liquid material is discharged from an outlet device.

### DESCRIPTION OF EMBODIMENTS

Hereinafter, a polishing pad material purification system (which will be hereinafter referred to simply as material purification system) according to an embodiment of the present invention will be described with reference to the attached drawings.

The material purification system purifies a material for producing polishing pads. The material purification system according to this embodiment purifies a liquid material by melting a solid material.

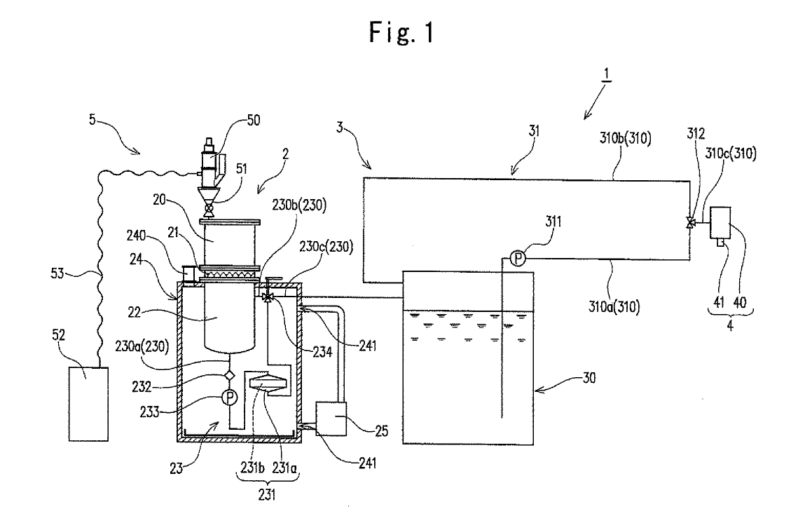

A more specific description will be given. As shown in FIG. 1, a material purification system 1 includes a melting device 2 configured to melt a solid material put therein, and a homogenizer 3 configured to homogenize the material melted in the melting device 2. The material purification system 1 further includes an outlet device 4 configured to discharge a liquid material homogenized by the homogenizer 3. The material purification system 1 further includes an inlet device 5 configured to put the solid material into the melting device 2. In this embodiment, the following description may be given with the material in solid state being referred to as solid material and the material changed from solid state to liquid state by melting being referred to as liquid material.

First, the inlet device 5 will be described. The inlet device 5 includes a hopper 50 having a supply port through which the solid material is supplied and a discharge port through which the supplied solid material is discharged to the melting device 2 (an inlet 20 of the melting device 2, which will be described below). The inlet device 5 further includes an on-off valve 51 arranged between the discharge port of the hopper 50 and the melting device 2. The inlet device 5 further includes a storage tank 52 in which the solid material is stored and which is connected to the supply port of the hopper 50 via a pipe member 53.

As described above, in the inlet device 5, the on-off valve 51 is arranged between the discharge port of the hopper 50 and the inlet 20. Therefore, in the inlet device 5, when the on-off valve 51 is opened, the input of the solid material from the hopper 50 into the melting device 2 is allowed, and when the on-off valve 51 is closed, the input of the solid material from the hopper 50 into the melting device 2 is restricted.

The melting device 2 includes the inlet 20 into which the solid material is put, and a melting unit 21 configured to melt the solid material put into the inlet 20. The melting device 2 further includes a storage 22 configured to store the material melted by the melting unit 21. The melting device 2 further includes a circulation system 23 configured to circulate the material melted by the melting unit 21. The melting device 2 further includes a housing 24 in which the storage 22 and the circulation system 23 are arranged, and a heat retaining unit 25 configured to maintain the temperature inside the housing 24 at a specific temperature (temperature at which the melted material can be maintained in the liquid state).

The inlet 20 is of a cylindrical shape. One open end of the inlet 20 is connected to the melting unit 21. Therefore, the solid material discharged from the hopper 50 via the on-off valve 51 is put in the inlet 20 according to this embodiment through the other open end of the inlet 20.

A heat-meltable material is put into the inlet 20. For example, 4,4′-methylenebis(o-chloroaniline) (so-called MOCA) is put into the inlet 20 according to this embodiment as a material. A material containing MOCA, materials such as 4,4′-diaminodiphenylmethane, m-phenylenediamine, diethylene toluenediamine (so-called DETDA), and trimethylolpropane may be put into the inlet 20.

The melting unit 21 heats the solid material put into the inlet 20, thereby changing it from solid state to liquid state. In the storage 22, the material changed from solid state to liquid state by the melting unit 21 is stored.

The circulation system 23 includes a flow path 230 fluidically connected to the storage 22. The circulation system 23 further includes a filtration device 231 connected to the flow path 230 and configured to filter the material circulated through the flow path 230. The circulation system 23 further includes a strainer 232 connected to the flow path 230, and a delivery pump 233 connected to the flow path 230 and arranged downstream of the strainer 232.

The flow path 230 includes a delivery pipe 230a into which the liquid material within the storage 22 flows, and a connection pipe 230b fluidically connected to each of the delivery pipe 230a and the storage 22. The flow path 230 further includes a supply pipe 230c fluidically connected to the delivery pipe 230a and the homogenizer 3 (a reservoir 30 of the homogenizer 3, which will be described below).

The circulation system 23 according to this embodiment further includes a supply valve 234 that can be switched between the state where the delivery pipe 230a and the connection pipe 230b communicate with each other and the state where the delivery pipe 230a and the supply pipe 230c communicate with each other.

Therefore, when the supply valve 234 is switched to the state where the delivery pipe 230a and the connection pipe 230b communicate with each other, the delivery pipe 230a, the connection pipe 230b, and the storage 22 communicate with one another, thereby forming a melting path serving as a circulation path through which the liquid material is circulated within the melting device 2. Then, the circulation of the liquid material from the delivery pipe 230a to the supply pipe 230c (that is, supply of the liquid material to the homogenizer 3) is restricted.

Meanwhile, when the supply valve 234 is switched to the state where the delivery pipe 230a and the supply pipe 230c communicate with each other, the circulation of the liquid material from the delivery pipe 230a to the supply pipe 230c (supply of the liquid material to the homogenizer 3) is allowed. Whilst, the circulation of the liquid material from the delivery pipe 230a to the connection pipe 230b is restricted.

The filtration device 231 includes a holder 231a in which the liquid material is circulated, and a filter medium 231b arranged in the holder 231a. The filtration device 231 is arranged downstream of the delivery pump 233 in the flow path 230 (the delivery pipe 230a).

The holder 231a includes an inflow port through which the liquid material in the flow path 230 flows therein, and an outflow port through which the liquid material thereinside is sent to the flow path 230.

The filter medium 231b is arranged between the inflow port and the outflow port. The mesh (pore size) of the filter medium 231b is smaller than the mesh of the strainer 232. In the filtration device 231, non-woven fabric, filter paper, or the like, is employed as the filter medium 231b.

The strainer 232 is constituted, for example, by a mesh made of metal or a perforated metal.

In the circulation system 23 according to this embodiment, a gear pump is employed as the delivery pump 233. The delivery pump 233 is not limited to the gear pump as long as it can circulate the material stored in the storage 22 within the circulation system 23.

The housing 24 includes an exhaust port 240 passing therethrough between the inside and the outside. The housing 24 includes a connection port 241 which communicates between the inside and the outside, the heat retaining unit 25 being connected to the connection part 241. The housing 24 can discharge air thereinside to the outside through the exhaust port 240.

The heat retaining unit 25 is configured to send hot air to the inside of the housing 24 via the connection port 241. Accordingly, the melting device 2 can maintain the temperature inside the housing 24 at a specific temperature by the hot air sent into the housing 24 from the heat retaining unit 25 via the connection port 241. Thereby, the melting device 2 can circulate the melted material through the melting path, while maintaining it in the liquid state.

The homogenizer 3 includes the reservoir 30 configured to store the liquid material sent out from the melting device 2, and a transport system 31 configured to circulate the liquid material stored in the reservoir 30.

The supply pipe 230c of the melting device 2 is fluidically connected to the reservoir 30.

The transport system 31 includes a transport path 310 fluidically connected to the reservoir 30. The transport system 31 includes a suction pump 311 configured to send the liquid material stored in the reservoir 30 into the transport path 310.

The transport path 310 includes an inflow pipe 310a through which the liquid material stored in the reservoir 30 flows therein, and a link pipe 310b fluidically connected to each of the inflow pipe 310a and the reservoir 30. The transport path 310 further includes an outlet pipe 310c fluidically connected to each of the delivery pipe 230a and the outlet device 4.

The transport system 31 according to this embodiment includes an outlet valve 312 that can be switched between the state where the inflow pipe 310a and the link pipe 310b communicate with each other and the state where the inflow pipe 310a and the outlet pipe 310c communicate with each other.

Therefore, when the outlet valve 312 is switched to the state where the inflow pipe 310a and the link pipe 310b communicate with each other, the inflow pipe 310a, the link pipe 310b, and the reservoir 30 communicate with one another, thereby forming a homogenizing path serving as a circulation path through which the liquid material is circulated within the homogenizer 3. Then, the circulation of the liquid material from the inflow pipe 310a to the outlet pipe 310c (that is, supply of the liquid material to the outlet device 4) is restricted.

Meanwhile, when the outlet valve 312 is switched to the state where the inflow pipe 310a and the outlet pipe 310c communicate with each other, the circulation of the liquid material from the inflow pipe 310a to the outlet pipe 310c (supply of the liquid material to the outlet device 4) is allowed. Whilst, the circulation of the liquid material from the inflow pipe 310a to the link pipe 310b is restricted.

In this embodiment, the processing amount (processable amount) of the material that the homogenizer 3 can homogenize is larger than the processing amount (processable amount) of the material that the melting device 2 can melt. A specific description is given below. The amount of the liquid material that is circulated through the homogenizing path of the homogenizer 3 is larger than the amount of the liquid material that is circulated through the melting path of the melting device 2.

The outlet device 4 includes a body 40 to which the liquid material is supplied from the transport system 31 of the homogenizer 3, and an outlet 41 from which the liquid material in the body 40 is discharged.

The outlet pipe 310c of the transport path 310 is fluidically connected to the body 40. Therefore, the liquid material supplied from the homogenizer 3 to the body 40 via the outlet pipe 310c is discharged from the outlet 41 in the outlet device 4. A material other than the material supplied from the homogenizer 3 may be supplied to the body 40. That is, a different kind of material may be supplied to the body 40.

The material purification system 1 according to this embodiment is as described above. Subsequently, the operation of the material purification system 1 according to this embodiment will be described with reference to the attached drawings.

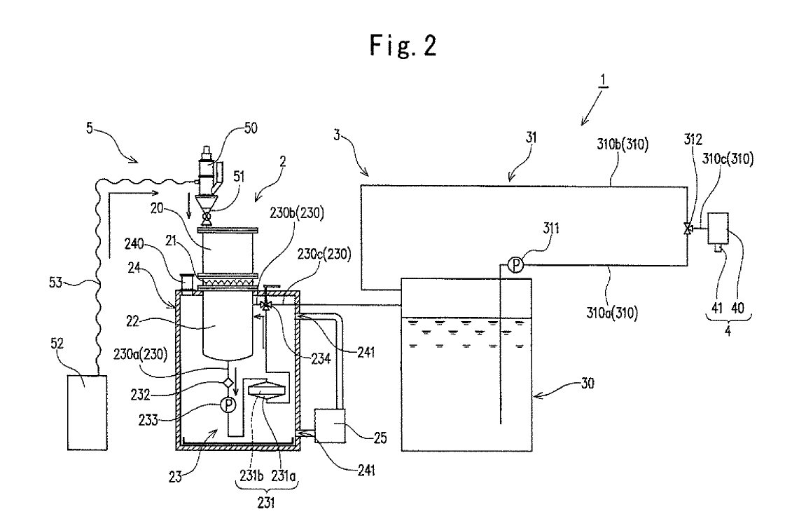

As shown in FIG. 2, for purifying a material for producing polishing pads using the material purification system 1 according to this embodiment, a solid material is put into the melting device 2 by the inlet device 5.

A more specific description will be given. First, after the on-off valve 51 is closed, the solid material is supplied from the storage tank 52 to the hopper 50 via the pipe member 53. Then, after the on-off valve 51 is opened, and the solid material within the hopper 50 is put into the inlet 20, the on-off valve 51 is closed.

In this way, in this embodiment, the solid material is stored once in the hopper 50, for intermittently putting the solid material from the hopper 50 to the inlet 20. Thereby, the input amount of the solid material from the hopper 50 into the inlet 20 is made uniform in this embodiment.

Then, the solid material put into the inlet 20 is melted by the melting unit 21. Thereby, the solid material put into the inlet 20 is changed from solid state to liquid state, so that the liquid material flows from the melting unit 21 into the storage 22. Then, the liquid material within the storage 22 is sent out to the delivery pipe 230a by the power of the delivery pump 233, passes through the strainer 232, and thereafter passes through the filtration device 231.

At this time, if a solid matter (such as foreign matter and a material that failed to be melted in the melting unit) is contained in the liquid material passing through the filtration device 231, such solid matter is separated from the liquid material by the filter medium 231b.

In this embodiment, for melting the solid material by the melting unit 21, the supply valve 234 is switched to allow the delivery pipe 230a and the connection pipe 230b to communicate with each other. That is, while the melting path is formed by the delivery pipe 230a, the connection pipe 230b, and the storage 22, the solid material is melted by the melting unit 21.

Therefore, the liquid material sent out from the storage 22 to the delivery pipe 230a by the power of the delivery pump 233 passes through the filtration device 231 and thereafter is sent out to the storage 22 via the connection pipe 230b.

Accordingly, the liquid material is circulated through the melting path by the power of the delivery pump 233 in the melting device 2, so that the liquid material is stirred in the melting device 2. Therefore, the occupation of the non-uniform melting or non-uniform mixing in the entire liquid material is reduced in the melting device 2, so that the entire liquid material is homogenized.

The melting device 2 according to this embodiment circulates the liquid material through the melting path, while maintaining the temperature inside the housing 24 at a specific temperature by the heat retaining unit 25, so as to be capable of melting the entire liquid material within the melting path more reliably.

When the supply valve 234 is switched to allow the delivery pipe 230a and the supply pipe 230c to communicate with each other, the liquid material sent out from the storage 22 to the delivery pipe 230a by the power of the delivery pump 233 passes through the supply pipe 230c and thereafter is sent out to the reservoir 30 of the homogenizer 3. Thereby, the liquid material is supplied from the melting device 2 to the homogenizer 3.

In this embodiment, for supplying the liquid material from the melting device 2 to the homogenizer 3, the outlet valve 312 is switched to allow the inflow pipe 310a and the link pipe 310b to communicate with each other. That is, the homogenizing path is formed by the inflow pipe 310a, the link pipe 310b, and the reservoir 30.

Therefore, the liquid material flowing from the supply pipe 230c into the reservoir 30 is sent out to the inflow pipe 310a by the suction pump 311 and thereafter is sent out to the reservoir 30 through the link pipe 310b. In this way, in the homogenizer 3, the liquid material is circulated through the homogenizing path by the power of the suction pump 311, so that the liquid material is stirred in the homogenizer 3. Accordingly, the occupation of non-uniform melting or non-uniform mixing in the entire liquid material within the melting device 2 is further reduced, and the liquid material is homogenized.

After the liquid material is further supplied from the melting device 2 to the homogenizer 3, a solid material is newly supplied from the storage tank 52 to the hopper 50 via the pipe member 53. Then, the on-off valve 51 is closed, after the solid material within the hopper 50 is put into the inlet 20 by opening the on-off valve 51 again.

The solid material that is newly put into the inlet 20 is also melted by the melting unit 21 to be changed from solid state to liquid state and is stored in the storage 22. Then, the liquid material within the storage 22 is sent out to the delivery pipe 230a by the power of the delivery pump 233, passes through the strainer 232, and thereafter passes through the filtration device 231.

In this embodiment, for melting the solid material that is newly put into the inlet 20 by the melting unit 21, the supply valve 234 is switched to allow the delivery pipe 230a and the connection pipe 230b to communicate with each other again. That is, the melting path is formed again by the delivery pipe 230a, the connection pipe 230b, and the storage 22. Therefore, the liquid material sent out from the storage 22 to the delivery pipe 230a by the power of the delivery pump 233 passes through the strainer 232 and the filtration device 231 and thereafter is sent out to the storage 22 through the connection pipe 230b.

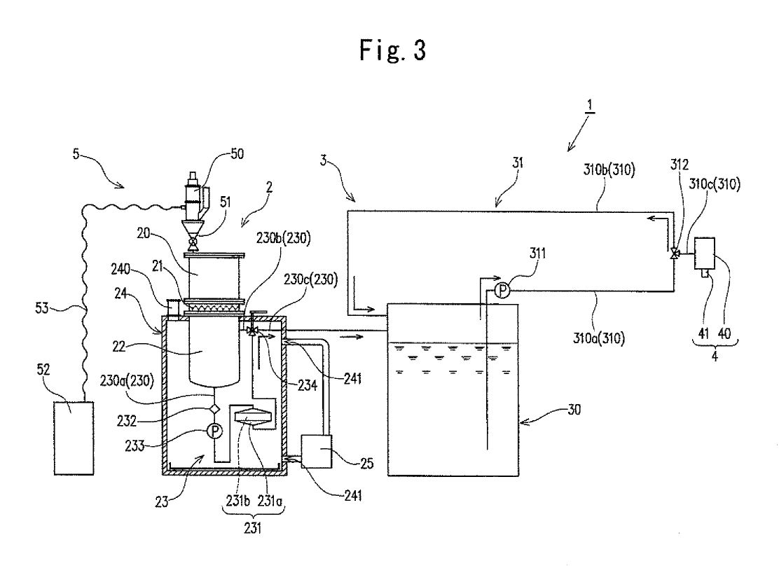

Then, as shown in FIG. 3, when the supply valve 234 is switched to allow the delivery pipe 230a and the supply pipe 230c to communicate with each other, the liquid material sent out by the power of the delivery pump 233 passes through the supply pipe 230c and thereafter is sent out to the reservoir 30 of the homogenizer 3.

As described above, since the processing amount of the material that the homogenizer 3 can homogenize is larger than the processing amount of the material that the melting device 2 can melt, the material melted later is circulated through the homogenizing path, when it is sent out to the reservoir 30 of the homogenizer 3, together with the liquid material supplied to the homogenizer 3 earlier (the material melted earlier). Thereby, the material melted earlier and the material melted later are stirred to be mixed together in the homogenizer 3. In this way, the material purification system 1 according to this embodiment can purify a homogenized material by storing the material melted earlier and the material melted later in the homogenizer 3 and mixing them together.

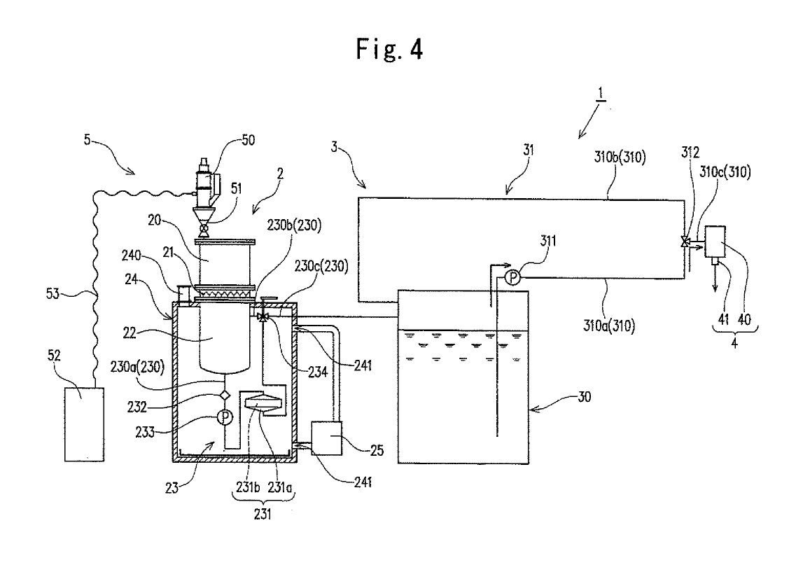

Further, as shown in FIG. 4, when the outlet valve 312 is switched to allow the inflow pipe 310a and the outlet pipe 310c to communicate with each other, the homogenized liquid material is discharged from the outlet 41 as a polishing pad material.

As described above, the material purification system 1 according to this embodiment includes the melting device 2 configured to melt the solid material put therein and the homogenizer 3 configured to homogenize the material melted in the melting device 2, and therefore the material that is changed from solid state to liquid state in the melting device 2 is stirred in the homogenizer 3 to be homogenized.

The processing amount of the material that the homogenizer 3 can homogenize is larger than the processing amount of the material that the melting device 2 can melt, and therefore both of the material melted earlier and the material melted later can be stirred to be mixed together in the homogenizer 3 by supplying the material melted later to the homogenizer 3 while stirring the material melted earlier in the homogenizer 3. In this way, the material purification system 1 can purify a material so as to allow higher homogeneity by making the quality of the material melted earlier and the quality of the material melted later uniform.

In the material purification system 1, the homogenizer 3 includes the homogenizing path through which the liquid material is circulated, and therefore the material newly melted by the melting device 2 and the liquid material supplied earlier from the melting device 2 to the homogenizer 3 can be mixed together and then circulated through the homogenizing path to be stirred. Accordingly, the homogeneity of the material purified in the material purification system 1 is further enhanced.

The melting device 2 is configured to stir the melted material so as to homogenize it. Therefore, the entire melted material can be stirred to be homogenized in the melting device 2. Accordingly, each of the material melted earlier and the material melted later is homogenized in the melting device 2, and then they are stirred to be mixed together in the homogenizer 3. Thus, the material purification system 1 can purify the material so as to allow higher homogeneity.

The melting device 2 further includes the melting path through which the melted material is circulated to be stirred, and therefore the melted material can be circulated through the melting path. Thereby, the entire melted material is stirred to be homogenized in the melting device 2. Accordingly, the material purification system 1 can purify the material so as to allow higher homogeneity.

The melting device 2 circulates the liquid material through the melting path while maintaining the temperature inside the housing 24 at a specific temperature by the heat retaining unit 25 and therefore can melt the entire liquid material within the melting path more reliably.

The melting device 2 can switch the supply valve 234 between the state where the liquid material is circulated through the melting path and the state where the liquid material is supplied to the homogenizer 3 and therefore can supply the liquid material to the homogenizer 3 after the liquid material is reliably stirred to be homogenized.

In the melting device 2 (the circulation system 23 of the melting device 2), the material melted by the melting unit 21 is filtered by the filtration device 231, and therefore the material is purified to have high purity.

The melting device 2 (the circulation system 23 of the melting device 2) includes the supply pipe 230c fluidically connected to the homogenizer 3, and therefore the material melted by the melting unit 21 is sent out from the melting device 2 to the homogenizer 3 without being exposed to the outside air. Accordingly, incorporation of foreign matter into the melted material is prevented in the material purification system 1, and therefore the material can be purified to have high purity.

The material purification system 1 according to the present invention is not limited to the aforementioned embodiment, and it is, of course, that various modifications can be made without departing from the gist of the present invention.

In the aforementioned embodiment, the flow path 230 includes the delivery pipe 230a into which the material stored in the storage 22 flows, the connection pipe 230b fluidically connected to each of the delivery pipe 230a and the storage 22, and the supply pipe 230c fluidically connected to the delivery pipe 230a and the homogenizer 3 (the reservoir 30 of the homogenizer 3, which will be described below), but there is no limitation to this configuration. For example, the flow path 230 may be configured not to include the connection pipe 230b.

In the aforementioned embodiment, the liquid material is intermittently supplied to the reservoir 30, but the liquid material may be continuously supplied to the reservoir 30. The melting device 2 needs only to be configured so that the liquid material within the storage 22 that is melted earlier and the liquid material that is newly melted and sent out into the storage 22 are mixed to be stirred in the storage 22, even if the flow path 230 does not include the connection pipe 230b. In this case, the melting device 2 may be configured, for example, so as to stir the liquid material within the storage 22 or so as to generate a flow by which the liquid material melted earlier and the liquid material newly melted are mixed within the storage 22.

In the aforementioned embodiment, the case where the solid material is intermittently put into the inlet 20 is described, but there is no limitation to this configuration. For example, the solid material may be melted in the melting unit 21 while the solid material is continuously put into the inlet 20.

In the aforementioned embodiment, the transport path 310 includes the inflow pipe 310a into which the liquid material stored in the reservoir 30 flows, the link pipe 310b fluidically connected to each of the inflow pipe 310a and the reservoir 30, and the outlet pipe 310c fluidically connected to each of the delivery pipe 230a and the outlet device 4, but there is no limitation to this configuration. For example, the homogenizer 3 needs only to be configured to mix the liquid material and stir it in the reservoir 30, even if the transport path 310 does not include the connection pipe 230b.

In the aforementioned embodiment, the liquid material is intermittently supplied to the body 40 of the outlet device 4, but the liquid material may be continuously supplied to the body 40 of the outlet device 4 in 26 the case where the transport path 310 does not include the link pipe 310b. However, in the case where the liquid material is continuously supplied to the body 40 of the outlet device 4, it is preferable that the amount of the liquid material that is supplied to the body 40 of the outlet device 4 (the amount of the liquid material that is discharged by the outlet device 4) be adjusted so that the liquid material constantly remains in the reservoir 30, so as to allow the material newly melted in the melting unit 21 and the material melted earlier in the melting unit 21 to be mixed together within the reservoir 30.

As described above, in the homogenizer 3, the method for supplying the liquid material to the outlet device 4 is not limited, as long as the material newly melted in the melting unit 21 and the material melted earlier in the melting unit 21 can be mixed together.

In the aforementioned embodiment, the supply pipe 230c of the flow path 230 is fluidically connected to the reservoir 30, but there is no limitation to this configuration. For example, the supply pipe 230c of the flow path 230 may be fluidically connected to the inflow pipe 310a or the link pipe 310b of the transport path 310.

In the aforementioned embodiment, the transport system 31 of the homogenizer 3 may include a filtration device connected to the transport path 310 and configured to filter the material circulated through the transport path 310, though not particularly specified. In this case, the filtration device needs only to be fluidically connected to the inflow pipe 310a or the link pipe 310b of the transport path 310.

In this way, when the liquid material is circulated through the reservoir 30, the inflow pipe 310a, and the link pipe 310b, the liquid material is filtered by the filtration device, and therefore the purity of the purified material is enhanced. In the material purification system 1 according to the aforementioned embodiment, only the transport system 31 of the homogenizer 3 may include the filtration device 231.

### REFERENCE SIGNS LIST

1: Material purification system
2: Melting device
3: Homogenizer
4: Outlet device
5: Inlet device
20: Inlet
21: Melting unit
22: Storage
23: Circulation system
24: Housing
25: Heat retaining unit
30: Reservoir
31: Transport system
40: Body
41: Outlet
50: Hopper
51: On-off valve
52: Storage tank
53: Pipe member
230: Flow path
230a: Delivery pipe
230b: Connection pipe
230c: Supply pipe
231: Filtration device
231a: Holder
231b: Filter medium
232: Strainer
233: Delivery pump
234: Supply valve
240: Exhaust port
241: Connection port
310: Transport path
310a: Inflow pipe
310b: Link pipe
310c: Outlet pipe
311: Suction pump
312: Outlet valve

1. A polishing pad material purification system comprising:
a melting device configured to melt a solid material; and
a homogenizer configured to homogenize the material melted in the melting device, wherein
the homogenizer is configured to have a processable amount of material to be homogenized larger than a processable amount of material to be melted by the melting device and configured to stir the material melted in the melting device so as to homogenize it.

2. The polishing pad material purification system according to claim 1, wherein
the melting device is configured to stir the melted material so as to homogenize it.

3. The polishing pad material purification system according to claim 2, wherein
at least any one of the melting device and the homogenizer comprises a circulation path through which the melted material is circulated to be stirred.

4. The polishing pad material purification system according to claim 1, wherein
at least any one of the melting device and the homogenizer comprises a filtration device configured to filter the melted material.

5. The polishing pad material purification system according to claim 1, wherein
the melting device comprises a supply pipe fluidically connected to the homogenizer.
